(19) United States
(12) Patent Application Publication
(10) Pub. No.: US 2025/0384731 A1
(43) Pub. Date: Dec. 18, 2025

(54) Vending Machine

(71) Applicants: Weihai New Beiyang Digital Technology Co., Ltd., Shandong (CN); Shandong New Beiyang Information Technology Co., Ltd., Shandong (CN)

(72) Inventors: Fengbo Xu, Shandong (CN); Jiabo Xu, Shandong (CN); Tianxin Jiang, Shandong (CN); Bo Liu, Shandong (CN)

(21) Appl. No.: 18/877,575

(22) PCT Filed: Jun. 21, 2023
(86) PCT No.: PCT/CN2023/101639

§ 371 Date: Dec. 20, 2024

(30) Foreign Application Priority Data
Jun. 24, 2022 (CN) 202210730280.6

(51) Int. Cl. G07F 11/16; F16H 19/04; G07F 17/32

(52) U.S. Cl. CPC G07F 11/163; F16H 19/04; G07F 17/329

(57) ABSTRACT

A vending machine includes a cabinet, a gate mechanism, a goods bucket, and a linkage mechanism. A storage region is provided in the cabinet, and a pickup port is defined on the cabinet; the gate mechanism includes a gate slidably mating with the cabinet and configured to open or close the pickup port; the goods bucket includes a housing and a delivery door, the housing has a delivery opening, and the delivery door is configured to open or close the delivery opening; the goods bucket has a receiving position and a delivery position when moving relative to the cabinet; the goods bucket is configured to receive goods from the storage region when the goods bucket is at the receiving position; when the goods bucket is at the delivery position, the gate opens the pickup port, and the delivery door opens the delivery opening, the delivery opening is opposite to and in communication with the pickup port; and the linkage mechanism is capable of linking the delivery door to the gate when the goods bucket moves toward the delivery position along a preset direction, such that the delivery door opens the delivery opening and the gate opens the pickup port

This application claims priority to Chinese Patent Application No. 202210730280.6 filed with the China National Intellectual Property Administration (CNIPA) on Jun. 24, 2022, the disclosure of which is incorporated herein by reference in its entirety.

### TECHNICAL FIELD

The present application relates to the field of smart devices, for example, a vending machine.

### BACKGROUND

A vending machine in the related art generally includes a cabinet, a gate, and a goods bucket movably disposed in the cabinet. A storage region for storing goods is provided in the cabinet, a pickup port is provided on the outer surface of the cabinet, and the gate movably mates with the cabinet to open or close the pickup port. The goods bucket is used for receiving goods output from the storage region and transporting the goods to the pickup port. The goods bucket includes a housing and a delivery door, the housing is provided with a delivery opening, and the delivery door slidably mates with the housing to open or close the delivery opening. When the goods bucket moves to the pickup port, the gate opens the pickup port, and the delivery door opens the delivery opening, the pickup port is opposite to and in communication with the delivery opening so that the goods in the goods bucket can be taken out through the pickup port and the delivery opening. However, the vending machine in the related art requires separate motors to drive the gate to open the pickup port and the delivery door to open the delivery opening, resulting in a complex structure and a relatively high cost.

### SUMMARY

The present application provides a vending machine where a gate and a delivery door are linked to open when a goods bucket moves to a delivery position. The vending machine is simple in structure and can effectively reduce a cost.

Embodiments of the present application provide a vending machine including a cabinet, a gate mechanism, a goods bucket, and a linkage mechanism.

A storage region for storing goods is provided in the cabinet, and a pickup port is defined on a surface of the cabinet.

The gate mechanism includes a gate slidably mating with the cabinet and configured to open or close the pickup port.

The goods bucket includes a housing and a delivery door, the housing has a delivery opening, the delivery door slidably mates with the housing to open or close the delivery opening, and when the delivery door closes the delivery opening, the delivery door and the housing form a receiving cavity for receiving goods. The goods bucket is movably disposed in the cabinet and has a receiving position and a delivery position. The goods bucket is configured to receive goods from the storage region when the goods bucket is at the receiving position. When the goods bucket is at the delivery position, the gate opens the pickup port, and the delivery door opens the delivery opening, the delivery opening is opposite to and in communication with the pickup port.

The linkage mechanism is capable of linking the delivery door to the gate when the goods bucket moves toward the delivery position along a preset direction, such that the delivery door opens the delivery opening and the gate opens the pickup port.

### BRIEF DESCRIPTION OF DRAWINGS

The drawings used in embodiments are described below. It is to be understood that the drawings below illustrate some embodiments of the present application, and those of ordinary skill in the art can obtain other relevant drawings based on these drawings on the premise that no creative work is done.

FIG. 1 is a structural view one of a vending machine according to an embodiment of the present application.

FIG. 2 is a structural view two of a vending machine according to an embodiment of the present application.

FIG. 3 is a partial enlarged view of part I of FIG. 2.

FIG. 4 is a partial enlarged view of part II of FIG. 2.

FIG. 5 is a partial structural view one of a vending machine according to an embodiment of the present application.

FIG. 6 is a structural view of a goods bucket of a vending machine according to an embodiment of the present application.

FIG. 7 is a partial structural view two of a vending machine according to an embodiment of the present application.

FIG. 8 is a partial enlarged view of part III of FIG. 7.

FIG. 9 is a partial structural view three of a vending machine according to an embodiment of the present application.

FIG. 10 is a partial structural view four of a vending machine according to an embodiment of the present application.

### REFERENCE LIST

100 vending machine
101 cabinet
102 cabinet body
103 cabinet door
105 printing device
106 barcode scanning device
107 banknote receiving device
108 card identification device
109 pickup port
110 storage region
111 ticket output device
112 delivery device
113 ticket dispensing device
115 goods bucket
117 vertical beam
119 horizontal beam
121 ticket bin
123 ticket cavity
125 first limiting piece
127 second limiting piece
128 gate mechanism
129 gate
131 housing
132 delivery door
133 goods entry opening
135 delivery opening
137 linkage mechanism
138 first transmission piece
139 second transmission piece
141 locking mechanism
142 locking piece
143 locking motor
145 worm
146 worm wheel
147 drive shaft
148 long slot
149 first drive portion
151 second drive portion
153 third drive portion
154 fourth drive portion
155 first protrusion
156 second protrusion
157 third protrusion
158 first transition assembly
159 first rack
161 second rack
163 transmission gear
165 first gear
167 second gear
168 guide groove
169 guide portion
170 first elastic element
171 support protrusion
172 connector
173 slide rail
174 slide groove
175 notch
176 locking hole
177 ticket output mechanism
178 first bin wall
179 second bin wall
180 receiving cavity

### DETAILED DESCRIPTION

Embodiments of the present application are described below in conjunction with drawings in the embodiments of the present application. The embodiments described below are part, not all, of embodiments of the present application.

Therefore, the following description of the embodiments of the present application shown in the drawings is not intended to limit the claimed scope of the present application and merely illustrates selected embodiments of the present application. Based on the embodiments of the present application, all other embodiments obtained by those of ordinary skill in the art without creative work are within the scope of the present application.

It is to be noted that similar reference numerals and letters represent similar items in the drawings. Therefore, once an item is defined in one drawing, the item no longer needs to be defined and interpreted in the subsequent drawings.

In the description of the present application, it is to be noted that orientations or position relations indicated by terms such as “center”, “upper”, “lower”, “left”, “right”, “vertical”, “horizontal”, “in”, and “out” are those shown based on the drawings or those in which the product of the present application is conventionally placed in use. These orientations or position relations are intended only to facilitate and simplify the description of the present application and not to indicate or imply that a device or element referred to must have such particular orientations or must be configured or operated in such particular orientations. Moreover, terms such as “first”, “second”, and “third” are used only for distinguishing description and are not to be construed as indicating or implying relative importance.

Additionally, terms such as “horizontal” and “vertical” indicate that components may be slightly inclined rather than being required to be absolutely horizontal or overhanging. For example, the term “horizontal” refers to that a direction is more horizontal than vertical and indicates that a structure may be slightly inclined rather than being completely horizontal.

In the description of the present application, it is to be further noted that terms “disposed”, “mounted”, “joined”, and “connected” are to be understood in a broad sense unless otherwise expressly specified and limited. For example, the term “connected” may refer to “securely connected”, “detachably connected”, or “integrated”, may refer to “mechanically connected” or “electrically connected”, or may refer to “connected directly”, “connected indirectly through an intermediary”, or “connected inside two components”. For those of ordinary skill in the art, meanings of the preceding terms in the present application may be understood based on situations.

In the related art, a vending machine requires separate motors to drive a gate and a delivery door to open or close and thus is complex in structure and high in cost. In view of this, an embodiment of the present application provides a vending machine where the linkage between a gate and a delivery door can be achieved under the drive of a goods bucket and which is simple in structure and can effectively reduce a cost. The structure of the vending machine is described below.

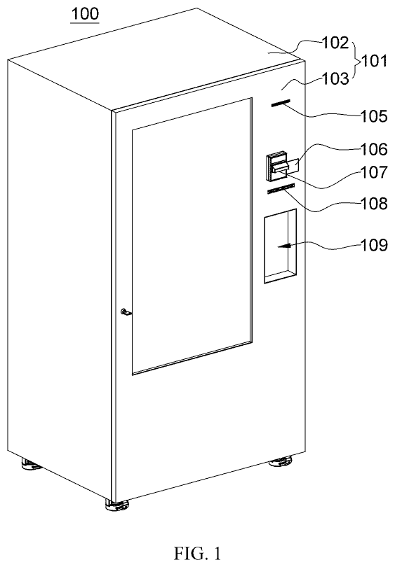

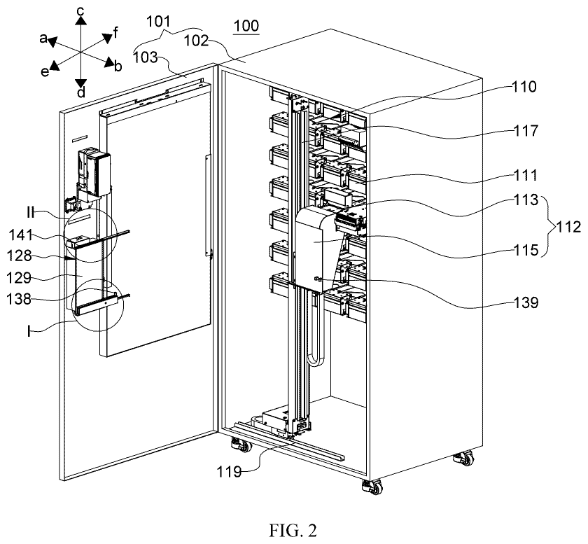

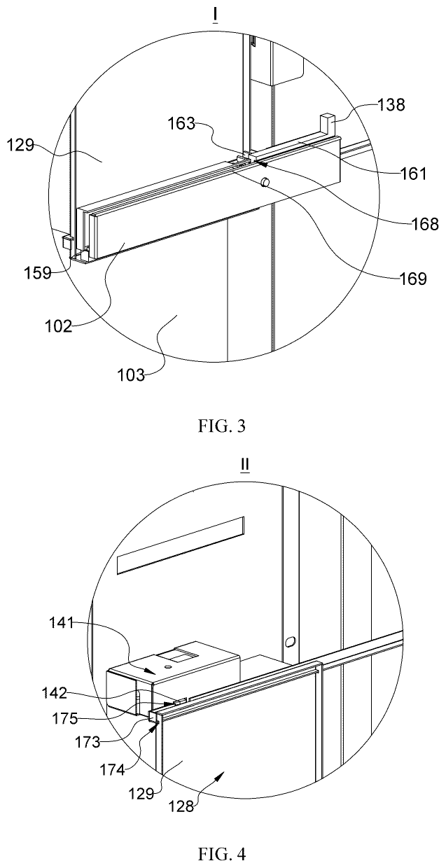

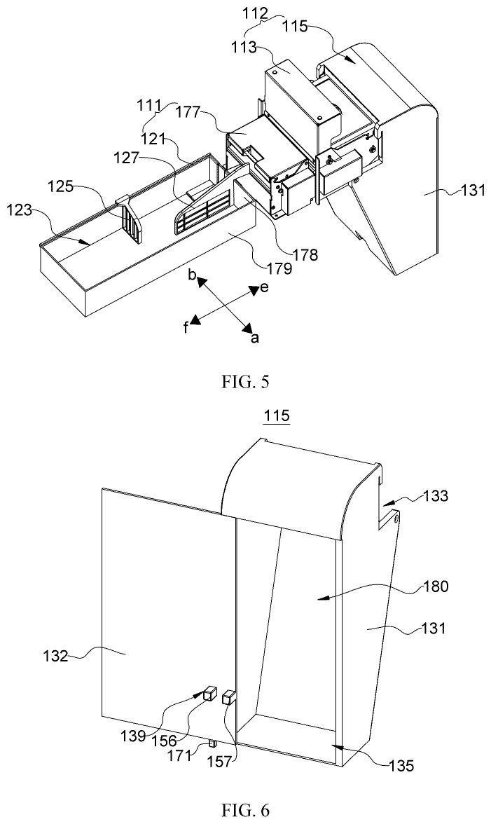

FIG. 1 is a structural view one of a vending machine 100 according to this embodiment. FIG. 2 is a structural view two of the vending machine 100 according to this embodiment. FIG. 3 is a partial enlarged view of part I of FIG. 2. FIG. 4 is a partial enlarged view of part II of FIG. 2. FIG. 5 is a partial structural view one of the vending machine 100 according to this embodiment. FIG. 6 is a structural view of a goods bucket 115 of the vending machine 100 according to this embodiment. Referring to FIGS. 1 to 6, the vending machine 100 according to this embodiment may be used for selling foods such as beverages or goods such as lottery tickets. The structure of the vending machine is described in this embodiment by using the selling of lottery tickets as an example. The vending machine 100 includes a cabinet 101, a gate mechanism 128, a ticket output device 111, a ticket dispensing device 113, a goods bucket 115, and a linkage mechanism 137.

The cabinet 101 is in the shape of a rectangular cuboid. The cabinet 101 may include a cabinet body 102 and a cabinet door 103. The cabinet body 102 is in the shape of a rectangular cuboid with an opening. A storage region 110 for storing lottery tickets is provided in the cabinet 101. The cabinet door 103 is movably disposed at the opening of the cabinet body 102. For example, the cabinet door 103 may be pivotally connected to the cabinet body 102, or the cabinet door 103 may slidably mate with the cabinet body 102. The cabinet door 103 can move relative to the cabinet body 102. In the process of moving relative to the cabinet body 102, the cabinet door 103 can open or close the opening. When the cabinet door 103 opens the opening, a merchant can supplement lottery tickets to be sold in the cabinet body 102 or can perform maintenance such as replacement and check on a structure in the cabinet 101. When the cabinet door 103 closes the opening, the vending machine 100 can sell the lottery tickets normally. Meanwhile, in order that a user conveniently takes away lottery tickets, a pickup port 109 is defined on a surface of the cabinet 101. In this embodiment, the pickup port 109 is defined on a surface of the cabinet door 103. In other embodiments, the pickup port 109 is defined on a surface of the cabinet body 102 as long as the user can conveniently take away the lottery tickets from the goods bucket 115 through the pickup port 109.

The gate mechanism 128 is disposed at the pickup port 109. The gate mechanism 128 includes a gate 129 slidably mating with the cabinet body 102 or the cabinet door 103 of the cabinet 101, and the gate 129 is configured to open or close the pickup port 109. When a ticket output operation is performed, the gate 129 slides relative to the cabinet 101 to enable the pickup port 109 to communicate with the inside of the cabinet 101 so that the user can conveniently take away the lottery tickets through the pickup port 109. When the ticket output operation is not performed, the gate 129 closes the pickup port 109 to prevent lawbreakers from acquiring lottery tickets in the cabinet 101 through the pickup port 109. In this embodiment, the pickup port 109 is defined on the cabinet door 103, the gate 129 slidably mates with the cabinet door 103, and the gate 129 can move along with the cabinet door 103 relative to the cabinet body 102.

The ticket output device 111, the ticket dispensing device 113, and the goods bucket 115 are all disposed in the cabinet body 102. N layers of plates are provided in the storage region 110, and the N layers of plates are arranged at intervals in an up and down direction. Multiple ticket output devices 111 are provided, and the multiple ticket output devices 111 are disposed on the N layers of plates separately and arranged in N rows and M columns. Each ticket output device 111 is configured to store lottery tickets and output lottery tickets to the ticket dispensing device 113. The ticket dispensing device 113 is fixedly connected to the goods bucket 115, and the ticket dispensing device 113 and the goods bucket 115 form a delivery device 112. The delivery device 112 can move in the cabinet 101 so that the goods bucket 115 has a receiving position and a delivery position. When the goods bucket 115 is at the receiving position, the ticket dispensing device 113 is opposite to one of the multiple ticket output devices 111 and can receive lottery tickets output from the opposite ticket output device 111 and output the lottery tickets to the goods bucket 115 for storage. When the goods bucket 115 is at the delivery position, the goods bucket 115 is opposite to the pickup port 109, and the user can take away the lottery tickets from the goods bucket 115 through the pickup port 109. With such setting, the delivery device 112 can be opposite to any ticket output device 111 when moving relative to the cabinet 101 so that the ticket dispensing device 113 can receive the lottery tickets output from the ticket output device 111. After receiving the lottery tickets, the ticket dispensing device 113 can output the lottery tickets to the goods bucket 115, where the lottery tickets are neatly stacked in the goods bucket 115. The goods bucket 115 can move to the pickup port 109 so that the user can conveniently take away the lottery tickets from the goods bucket 115.

That is, after such setting, the delivery device 112 can move between the multiple ticket output devices 111 and the pickup port 109 to transport lottery tickets so that the pickup port 109 can be disposed at any height of the cabinet door 103, and an operator can conveniently take out the lottery tickets through the pickup port 109 in a comfortable posture. Moreover, the multiple ticket output devices 111 share the same ticket dispensing device 113, reducing the cost of the vending machine 100.

It is to be noted that in this embodiment, considering particularities of the lottery ticket in shape and structure, the lottery ticket is relatively thin. If the lottery tickets are directly output from the ticket output device 111 to the goods bucket 115, the lottery tickets may be difficult to stack neatly in the goods bucket 115. Therefore, the ticket dispensing device 113 is disposed in this embodiment to ensure that the lottery tickets can be stacked neatly in the goods bucket 115. However, in other embodiments, when the vending machine 100 is used for selling some beverages and other foods, the above problem does not require consideration and thus the ticket dispensing device 113 can be omitted.

It is to be further noted that in this embodiment, to ensure that the delivery device 112 can move between the ticket output devices 111 and the pickup port 109, in this embodiment, a horizontal beam 119 and a vertical beam 117 are provided in the cabinet 101, and a first drive mechanism and a second drive mechanism are also provided in the cabinet 101. The horizontal beam 119 is disposed at the bottom or top of the cabinet body 102 adjacent to the opening of the cabinet body 102, and the horizontal beam 119 extends along a left and right direction (which is a horizontal direction and also a direction indicated by arrows a and b in FIG. 1). The vertical beam 117 is disposed adjacent to the opening of the cabinet body 102, and the vertical beam 117 extends along the up and down direction (which is a vertical direction and also a direction indicated by arrows c and d in FIG. 1). The first drive mechanism is drivingly connected between the horizontal beam 119 and the vertical beam 117 and can drive the vertical beam 117 to move along the horizontal beam 119. The second drive mechanism is drivingly connected between the goods bucket 115 and the vertical beam 117 or between the ticket dispensing device 113 and the vertical beam 117 and can drive the delivery device 112 to move along the vertical beam 117. That is, the first drive mechanism is configured to drive the delivery device 112 to move along the left and right direction, and the second drive mechanism is configured to drive the delivery device 112 to move along the up and down direction. With such setting, the delivery device 112 can move adjacent to the opening along the left and right direction and the up and down direction in the cabinet body 102 so that the ticket dispensing device 113 can be opposite to any one of the multiple ticket output devices 111 and acquire the lottery tickets output from any ticket output device 111, and the goods bucket 115 can be opposite to the pickup port 109 and thus the user can take away the lottery tickets from the goods bucket 115 through the pickup port 109.

Each of the first drive mechanism and the second drive mechanism can optionally be a combination of a motor and a gear assembly or a combination of a motor and a transmission belt assembly. Meanwhile, the horizontal beam 119 may be provided with an insertion groove extending along the left and right direction, and the first drive mechanism can be inserted into the insertion groove through an insertion column so that the vertical beam 117 can be driven by the motor to move along the left and right direction, and the goods bucket 115 and the ticket dispensing device 113 can move along the left and right direction. The vertical beam 117 may be provided with an insertion groove extending along the up and down direction, and the second drive mechanism can be inserted into the insertion groove through an insertion column so that the goods bucket 115 and the ticket dispensing device 113 can be driven by the motor to move along the up and down direction. For structures of the first drive mechanism and the second drive mechanism, reference may be made to the related art.

Additionally, it is to be noted that in this embodiment, the vending machine 100 further includes a controller which may optionally be a programmable logic controller, a single-chip microcomputer, or a computer. The controller can control the motions of the ticket output device 111, the ticket dispensing device 113, the goods bucket 115, the first drive mechanism, the second drive mechanism, and other structures. For example, when the ticket output operation is performed, the controller can control the first drive mechanism and the second drive mechanism to drive the delivery device 112 to move to such a position that the ticket dispensing device 113 is opposite to a target ticket output device 111, and control the ticket output device 111 to output the lottery tickets to the ticket dispensing device 113, and then control the ticket dispensing device 113 to convey the lottery tickets to the goods bucket 115, and then control the first drive mechanism and the second drive mechanism to drive the delivery device 112 to move toward the pickup port 109 so that the goods bucket 115 is opposite to the pickup port 109, and the user can take away the lottery tickets from the goods bucket 115 through the pickup port 109.

Still referring to FIG. 5, to ensure that the ticket output device 111 can efficiently output the lottery tickets to the ticket dispensing device 113 and to ensure that the ticket dispensing device 113 can output the received lottery tickets to the goods bucket 115 for stacking, in this embodiment, the ticket output device 111 may include a ticket bin 121 and a ticket output mechanism 177. The ticket bin 121 has a ticket cavity 123 for storing lottery tickets to be sold. The lottery tickets to be sold may be in a rolled or folded shape. In this embodiment, the folded shape is used as an example. The ticket output mechanism 177 includes two rotating rollers opposite to each other. The two rotating rollers are configured to clamp the lottery ticket drawn from the ticket bin 121 and drive the lottery ticket to move toward the ticket dispensing device 113. The ticket dispensing device 113 includes a conveying assembly, a cutting assembly, and an identification assembly which are all electrically or communicatively connected to the controller. The ticket dispensing device 113 has a ticket dispensing channel for conveying the lottery ticket. The conveying assembly includes two conveying rollers opposite to each other in the ticket dispensing channel. The two conveying rollers can clamp the lottery ticket and drive the lottery ticket to move forward or backward in the ticket dispensing channel. The identification assembly is configured to collect information about the lottery ticket in the ticket dispensing channel. The cutting assembly is configured to cut off multiple consecutive lottery tickets. When the ticket output operation is performed, the ticket dispensing channel receives the lottery ticket output from the ticket output mechanism 177, the identification assembly collects the information about the lottery ticket in the ticket dispensing channel and sends the information to the controller, the controller activates the lottery ticket, and after the lottery ticket is activated, the controller controls the cutting assembly to cut off multiple consecutive lottery tickets into single lottery tickets and controls the conveying assembly to distribute the cut lottery tickets to the goods bucket 115. The ticket dispensing device 113 repeats the above actions so that the multiple cut lottery tickets are conveyed to the goods bucket 115 and stacked in the goods bucket 115.

It is to be noted that to ensure the positional stability of the lottery tickets in the ticket bin 121, a first limiting piece 125 and a second limiting piece 127 that can slidably mate with the ticket bin 121 may be provided in the ticket cavity 123 of the ticket bin 121 as required. The first limiting piece 125 extends along the left and right direction and can move relative to the ticket bin 121 along a front and rear direction (which is a horizontal direction and also a direction indicated by arrows e and f in FIGS. 1 and 5). The second limiting piece 127 extends along the front and rear direction and can move relative to the ticket bin 121 along the left and right direction (which is a horizontal direction and also a direction indicated by the arrows a and b in FIGS. 1 and 5). The first limiting piece 125 and the second limiting piece 127 can jointly limit the position of the lottery tickets in the ticket cavity 123 to adapt to lottery tickets of different sizes, prevent the lottery tickets from moving in the ticket cavity 123, ensure the positional stability of the lottery tickets in the ticket cavity 123, and fully improve the stability and reliability of the ticket output operation of the ticket output device 111.

For example, the ticket bin 121 is in the shape of a box and includes first bin walls 178 extending along the left and right direction and second bin walls 179 extending along the front and rear direction. Each of the first limiting piece 125 and the second limiting piece 127 is provided with a slide groove. The slide groove on the first limiting piece 125 is snap-fitted with a second bin wall 179. The first limiting piece 125 can slide along the second bin wall 179 to adjust a position of the first limiting piece 125 along the front and rear direction. The slide groove on the second limiting piece 127 is snap-fitted with a first bin wall 178. The second limiting piece 127 can slide along the first bin wall 178 to adjust a position of the second limiting piece 127 along the left and right direction. In other embodiments, the positions of the first limiting piece 125 and the second limiting piece 127 may be adjusted by a motor or another linear drive structure. Of course, in other embodiments, the first limiting piece 125 and the second limiting piece 127 may be connected to the ticket bin 121 in an inserted manner.

Additionally, in other embodiments, the ticket output device 111 may be a structure into which a drive piece and a push piece are combined, the drive piece can drive the push piece to move in the front and rear direction, and the push piece outputs the lottery tickets to the ticket dispensing device 113.

Still referring to FIGS. 5 and 6, to ensure that the user can take away the lottery tickets in time after the goods bucket 115 transports the stacked lottery tickets to the pickup port 109, in this embodiment, the goods bucket 115 may include a housing 131 and a delivery door 132. Two sides of the housing 131 are respectively provided with a goods entry opening 133 and a delivery opening 135. The goods entry opening 133 communicates with the ticket dispensing channel of the ticket dispensing device 113 and can receive the lottery tickets output from the ticket dispensing channel. The delivery door 132 is movably disposed at the delivery opening 135 to open or close the delivery opening 135. When the delivery door 132 closes the delivery opening 135, the delivery door 132 and the housing 131 form a receiving cavity 180 for receiving goods. When the goods bucket 115 is driven by the first drive mechanism and the second drive mechanism to move to the receiving position, the ticket dispensing device 113 receives the lottery tickets output from the ticket output device 111, and the goods entry opening 133 of the housing 131 can receive the lottery tickets output from the ticket dispensing channel of the ticket dispensing device 113 and stack the multiple lottery tickets in the receiving cavity 180. When the goods bucket 115 is driven by the first drive mechanism and the second drive mechanism to move to the delivery position, the gate 129 opens the pickup port 109, and the delivery door 132 opens the delivery opening 135, the delivery opening 135 is opposite to and in communication with the pickup port 109 and the user can take away the lottery tickets in the receiving cavity 180 through the pickup port 109 and the delivery opening 135.

Since both the delivery opening 135 and the pickup port 109 are required to be opened for the user to take away the lottery tickets in the receiving cavity 180 of the goods bucket 115, separate mechanisms are often required to drive the delivery door 132 and the gate 129 to move, resulting in a complex structure and a relatively high cost. Therefore, in this embodiment, the vending machine 100 further includes the linkage mechanism 137. The linkage mechanism 137 can link the delivery door 132 to the gate 129 when the goods bucket 115 moves toward the delivery position along a preset direction, such that the delivery door 132 opens the delivery opening 135 and the gate 129 opens the pickup port 109. That is, in one aspect, the vending machine 100 is provided with the linkage mechanism 137 so that the motion of the goods bucket 115 in the original delivery process can drive the gate 129 and the delivery door 132 to move. Thus, separate drive structures are no longer required to be disposed for the gate 129 and the delivery door 132, thereby simplifying the structure and saving the cost. In the other aspect, during the motion of the goods bucket 115 to the delivery position, the gate 129 is linked to the delivery door 132, that is, when the gate 129 opens the pickup port 109, the delivery door 132 opens the delivery opening 135. That is, the motion of the goods bucket 115 to the delivery position occurs simultaneously with at least one of the following two actions: the delivery door 132 opens the delivery opening 135 or the gate 129 opens the pickup port 109, thereby improving delivery efficiency, reducing a waiting time of the user, and improving user experience.

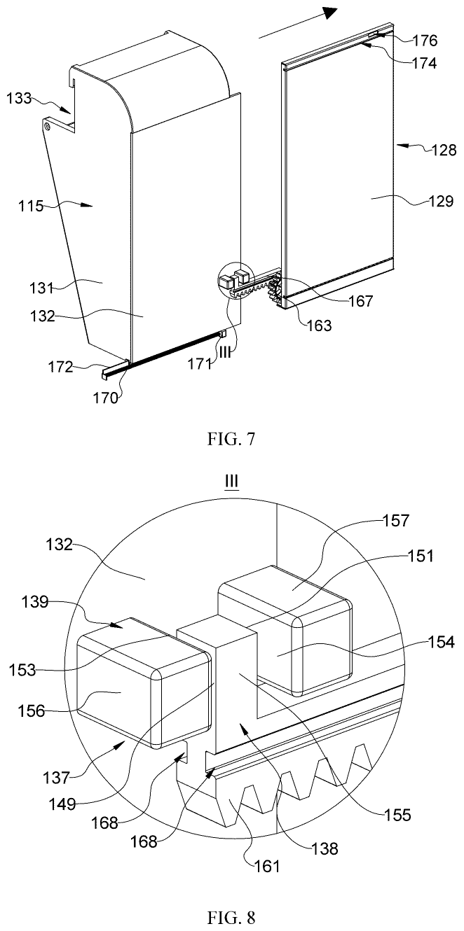

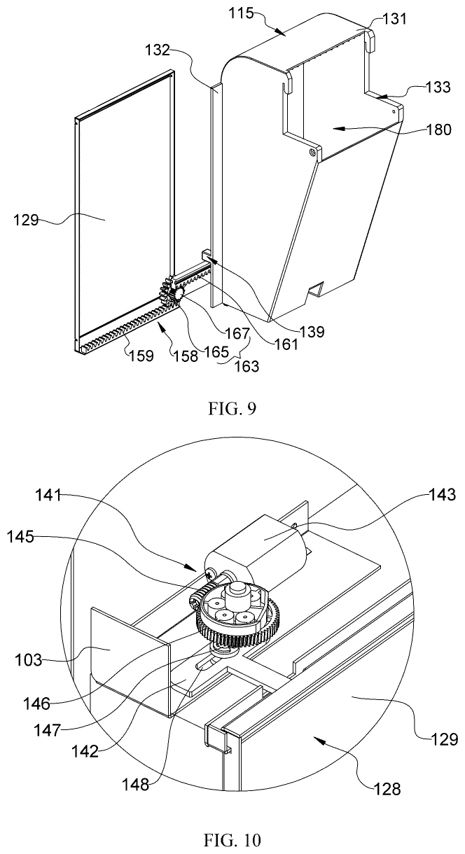

FIG. 7 is a partial structural view two of the vending machine 100 according to this embodiment. FIG. 8 is a partial enlarged view of part III of FIG. 7. FIG. 9 is a partial structural view three of the vending machine 100 according to this embodiment. Referring to FIGS. 2 to 9, in this embodiment, the linkage mechanism 137 includes a first transmission piece 138 and a second transmission piece 139 that can mate with each other. The first transmission piece 138 is connected to the gate 129, where the connection manner may be a fixed connection or a transmission connection. The second transmission piece 139 is connected to the delivery door 132, where similarly, the connection manner may be a fixed connection or a transmission connection. When the first transmission piece 138 and the second transmission piece 139 mate with each other and the goods bucket 115 moves toward the delivery position along the preset direction, the second transmission piece 139 drives the first transmission piece 138 to drive the gate 129 to open the pickup port 109, and the first transmission piece 138 drives the second transmission piece 139 to drive the delivery door 132 to open the delivery opening 135, so that the delivery opening 135 is opposite to and in communication with the pickup port 109.

With such setting, when the ticket output operation is performed, the ticket output device 111 outputs the lottery tickets to the ticket dispensing device 113, and the ticket dispensing device 113 conveys the lottery tickets to the goods bucket 115. The controller controls the first drive mechanism and the second drive mechanism to drive the goods bucket 115 to move toward the pickup port 109 and controls the second transmission piece 139 of the goods bucket 115 and the first transmission piece 138 to mate with each other. At this time, the goods bucket 115 continues to move along the preset direction under the drive of the first drive mechanism and the second drive mechanism so that the second transmission piece 139 drives the first transmission piece 138 to drive the gate 129 to open the pickup port 109 and the first transmission piece 138 drives the second transmission piece 139 to drive the delivery door 132 to open the delivery opening 135. When the goods bucket 115 moves to the delivery position, the delivery opening 135 and the pickup port 109 are both opened, and the delivery opening 135 is opposite to and in communication with the pickup port 109 so that the user can directly take away the lottery tickets in the receiving cavity 180 through the pickup port 109 and the delivery opening 135. That is, the process of opening the delivery opening 135 and the pickup port 109 only requires power for the goods bucket 115 to move toward the delivery position (that is, a driving force of the first drive mechanism and the second drive mechanism), and additional drive structures are not required so that the structure can be fully simplified and the cost can be saved.

Optionally, the preset direction is either horizontally leftward or horizontally rightward; or the preset direction is either vertically upward or vertically downward. For example, still referring to FIG. 7, since the goods bucket 115 is disposed in the cabinet 101, to reduce a space occupied in the process of the delivery door 132 opening or closing the delivery opening 135, in this embodiment, the preset direction is horizontally rightward (that is, a direction indicated by an arrow in FIG. 7), and the delivery door 132 may optionally be slidably connected to the housing 131. For example, one of the housing 131 and the delivery door 132 may be provided with a sliding groove extending along the left and right direction, and the other of the housing 131 and the delivery door 132 may be provided with a sliding portion that slidably mates with the sliding groove.

Meanwhile, still referring to FIG. 4, in this embodiment, one of the cabinet 101 and the gate 129 is provided with a slide rail 173 extending along the left and right direction, the other of the cabinet 101 and the gate 129 is provided with a slide groove 174 extending along the left and right direction, and the slide groove 174 slidably mates with the slide rail 173. When the second transmission piece 139 and the first transmission piece 138 mate with each other and the goods bucket 115 moves horizontally rightward to the delivery position, the second transmission piece 139 drives the first transmission piece 138 to drive the gate 129 to move so that the slide groove 174 and the slide rail 173 slide relative to each other, so that the gate 129 opens the pickup port 109, and the first transmission piece 138 drives the second transmission piece 139 to drive the delivery door 132 to move so that the sliding groove and the sliding portion slide relative to each other, so that the delivery door 132 opens the delivery opening 135. When the goods bucket 115 moves to the delivery position, the delivery opening 135 and the pickup port 109 are both opened, and the delivery opening 135 is opposite to the pickup port 109.

It is to be noted that in this embodiment, the slide rail 173 is disposed on the cabinet door 103, the slide groove 174 is disposed on the gate 129, two slide grooves 174 are respectively disposed adjacent to two ends of the gate 129 in the up and down direction, and correspondingly, two slide rails 173 are disposed so that the two slide rails 173 can respectively slidably mate with the two slide grooves 174, so as to fully improve the motion smoothness and reliability of the gate 129. In other embodiments of the present application, the slide rail 173 may be disposed on the cabinet body 102.

Optionally, the goods bucket 115 further includes a first elastic element 170, the first elastic element 170 is connected between the housing 131 and the delivery door 132, the first elastic element 170 is configured to make the delivery door 132 always have a motion tendency to close the delivery opening 135, and the delivery door 132 can close the delivery opening 135 under the action of the first elastic element 170 and/or the gravity of the delivery door 132. For example, a connector 172 is fixedly provided on a side of the bottom of the housing 131 near the vertical beam 117, a support protrusion 171 is fixedly provided away from the vertical beam 117 at the bottom end of the delivery door 132, the support protrusion 171 and the connector 172 are spaced apart in the left and right direction, and the first elastic element 170 is connected between the support protrusion 171 and the connector 172. The first elastic element 170 may be a compression spring. The first elastic element 170 is configured to make the delivery door 132 always have the motion tendency to close the delivery opening 135 so that the delivery door 132 that opens the delivery opening 135 can close the delivery opening 135 under the action of the first elastic element 170 and/or the gravity of the delivery door 132.

Optionally, according to a requirement, the gate mechanism 128 may be provided with a second elastic element connected between the gate 129 and the cabinet 101. The second elastic element is configured to make the gate 129 always have a motion tendency to close the pickup port 109 so that the gate 129 can close the pickup port 109 under the action of the second elastic element and/or the gravity of the gate 129.

With such setting, when the first transmission piece 138 and the second transmission piece 139 mate with each other and the goods bucket 115 moves toward the delivery position along the preset direction, the first transmission piece 138 drives the second transmission piece 139 to drive the delivery door 132 to overcome a resilient force of the first elastic element 170 and move a set distance in a direction for opening the delivery opening 135. In this process, the first elastic element 170 is deformed. When the resilient force generated due to the deformation of the first elastic element 170 is greater than a thrust required to push the first transmission piece 138, the second transmission piece 139 drives the first transmission piece 138 to drive the gate 129 to move to a position for opening the pickup port 109. At this time, the gate 129 is blocked and cannot continue to move. Then, the first transmission piece 138 drives the second transmission piece 139 to drive the delivery door 132 to continue to overcome the resilient force of the first elastic element 170 and move to a position for opening the delivery opening 135. When the delivery door 132 is required to close, the goods bucket 115 is simply driven to move so that the first transmission piece 138 is disengaged from the second transmission piece 139, the gate 129 moves to a position for closing the pickup port 109 under the action of the second elastic element and/or the gravity of the gate 129, and the delivery door 132 moves to a position for closing the delivery opening 135 under the action of the first elastic element 170 and/or the gravity of the delivery door 132. With such setting, higher linkage efficiency is achieved, the delivery opening 135 and the pickup port 109 can not only be opened but also be closed, and the first transmission piece 138 and the second transmission piece 139 mate more stably and reliably.

As an optional solution, still referring to FIGS. 2, 4, and 7, in this embodiment, the gate mechanism 128 may be further provided with a locking mechanism 141 as required, the locking mechanism 141 is disposed at a position of the cabinet body 102 or the cabinet door 103 adjacent to the top of the gate 129, the gate 129 is provided with a locking hole 176 (see FIG. 7), and a notch 175 is provided at the corresponding position of the slide rail 173. The locking mechanism 141 includes a locking piece 142 and a locking motor 143. The locking piece 142 is slidably connected to the cabinet 101, and the locking piece 142 can slide between a locking position and an unlocking position relative to the cabinet 101. The locking motor 143 is drivingly connected to the locking piece 142 and configured to drive the locking piece 142 to slide between the locking position and the unlocking position. When the gate 129 closes the pickup port 109 and the locking piece 142 is at the locking position, the locking piece 142 passes through the notch 175 and is inserted into the locking hole 176 on the gate 129 so that the gate 129 is locked at the position for closing the pickup port 109. When the locking piece 142 is at the unlocking position, the locking piece 142 exits the locking hole 176 and the notch 175 and is disengaged from the gate 129 so that the gate 129 can be driven by the first transmission piece 138 to move to the position for opening the pickup port 109. The locking mechanism 141 is disposed so that the gate 129 does not open by accident, and the safety and stability of the lottery tickets in the cabinet 101 can be ensured.

For example, FIG. 10 is a partial structural view four of the vending machine 100 according to this embodiment. Referring to FIGS. 4 and 10, in this embodiment, an output shaft of the locking motor 143 is provided with a worm 145, the locking mechanism 141 further includes a worm wheel 146 disposed on the cabinet 101, the worm wheel 146 meshes with the worm 145, a drive shaft 147 is fixedly provided on an end surface of the worm wheel 146, the drive shaft 147 is spaced apart from a rotation axis of the worm wheel 146, the locking piece 142 is provided with a long slot 148, and the drive shaft 147 is inserted into the long slot 148. When the locking motor 143 drives the worm wheel 146 through the worm 145 to rotate, and the drive shaft 147 abuts against a side wall of the long slot 148 to drive the locking piece 142 to move between the locking position and the unlocking position. It is to be noted that in this embodiment, a motion direction of the locking piece 142 may be perpendicular to an extension direction of the long slot 148 to ensure that the drive shaft 147 can drive the locking piece 142 through the long slot 148 to move, thereby ensuring the motion smoothness and reliability of the locking piece 142.

Still referring to FIGS. 2 to 4 and 6 to 9, in order to ensure the motion smoothness and reliability of the linkage mechanism 137, to ensure the efficient ticket output operation, in this embodiment, the first transmission piece 138 is located on a side of the gate 129 near a pivotal position between the cabinet door 103 and the cabinet body 102, and the first transmission piece 138 includes a first drive portion 149 and a second drive portion 151 spaced apart from each other; and the second transmission piece 139 is located on a side of the delivery door 132 away from the pivotal position between the cabinet door 103 and the cabinet body 102, and the second transmission piece 139 includes a third drive portion 153 and a fourth drive portion 154 spaced apart from each other. As the goods bucket 115 moves, the third drive portion 153 can abut against the first drive portion 149, and the fourth drive portion 154 can abut against the second drive portion 151. For example, when the third drive portion 153 abuts against the first drive portion 149 and the goods bucket 115 moves toward the delivery position along the preset direction (for example, horizontally rightward), the third drive portion 153 can drive the first drive portion 149 to drive the gate 129 to move horizontally rightward to open the pickup port 109, and the first drive portion 149 can drive the third drive portion 153 to drive the delivery door 132 to move horizontally leftward to open the delivery opening 135. Conversely, when the fourth drive portion 154 abuts against the second drive portion 151 and the goods bucket 115 leaves the delivery position in a direction opposite to the preset direction (for example, horizontally leftward), the fourth drive portion 154 drives the second drive portion 151 to drive the gate 129 to move horizontally leftward to close the pickup port 109, and the second drive portion 151 drives the fourth drive portion 154 to drive the delivery door 132 to move horizontally rightward to close the delivery opening 135.

With such setting, when the user needs to pick up goods, the third drive portion 153 is simply made abut against the first drive portion 149 and the goods bucket 115 is simply driven to move toward the delivery position along the preset direction. When the goods bucket 115 moves along the preset direction, the delivery door 132 opens the delivery opening 135, and the gate 129 opens the pickup port 109. When the goods bucket 115 is at the delivery position, the delivery opening 135 is opposite to and in communication with the pickup port 109, and the user can take away the lottery tickets from the goods bucket 115 through the pickup port 109 and the delivery opening 135. After the user takes away the lottery tickets, the goods bucket 115 is simply driven to move in the direction opposite to the preset direction to make the fourth drive portion 154 abut against the second drive portion 151 and then can drive the delivery door 132 to close the delivery opening 135 and the gate 129 to close the pickup port 109. With such setting, the motion of the goods bucket 115 can drive the gate 129 and the delivery door 132 to be linked to open or close so that additional motors are not required to drive the gate 129 and the delivery door 132 to open or close, thereby reducing the cost.

It is to be noted that in this embodiment, the preset direction is either horizontally leftward or horizontally rightward, for example, the preset direction is horizontally rightward, and the direction opposite to the preset direction is horizontally leftward. Therefore, the first drive portion 149 and the second drive portion 151 are spaced apart in the left and right direction, and the third drive portion 153 and the fourth drive portion 154 are also spaced apart in the left and right direction. With such setting, the goods bucket 115 is simply driven by the first drive mechanism and the second drive mechanism to move toward the delivery position so that the first transmission piece 138 mates with the second transmission piece 139 and then to move leftward and rightward so that the gate 129 and the delivery door 132 are linked to open or close. Thus, the motion reliability and stability of the gate 129 and the delivery door 132 can be fully improved, and the delivery and pickup efficiency can also be improved.

Of course, in other embodiments, the preset direction may be either vertically upward or vertically downward, and the direction opposite to the preset direction may be just opposite. In this case, the first drive portion 149 and the second drive portion 151 are spaced apart in the up and down direction, the third drive portion 153 and the fourth drive portion 154 may also be spaced apart in the up and down direction, and the slide rail 173, the slide groove 174, and the sliding groove may be correspondingly adjusted to extend along the up and down direction.

It is to be further noted that in other embodiments, a position of the first transmission piece 138 relative to the gate 129 and a position of the second transmission piece 139 relative to the delivery door 132 may be changed. The positions are changed so that when the goods bucket 115 moves rightward (that is, the preset direction is horizontally rightward), the linkage mechanism 137 enables the gate 129 to move rightward to open the pickup port 109 and the delivery door 132 to move leftward to open the delivery opening 135. Similarly, when the goods bucket 115 moves leftward, the linkage mechanism 137 enables the gate 129 to move leftward to close the pickup port 109 and the delivery door 132 to move rightward to close the delivery opening 135. Additionally, in other embodiments, a motion direction of the gate 129 and the preset direction may be arranged at an angle, and a motion direction of the delivery door 132 and the preset direction may also be arranged at an angle. In this case, the extension directions of the slide rail 173, the slide groove 174, and the sliding groove are correspondingly adjusted so that the extension directions of the slide rail 173, the slide groove 174, and the sliding groove are the same as the motion direction of the gate 129.

Still referring to FIGS. 7 to 9, in this embodiment, the first transmission piece 138 includes a first protrusion 155, the first drive portion 149 and the second drive portion 151 are both disposed on the first protrusion 155, and the first drive portion 149 and the second drive portion 151 are two surfaces of the first protrusion 155 facing away from each other and spaced apart in the left and right direction; and the second transmission piece 139 includes a second protrusion 156 and a third protrusion 157 spaced apart in the left and right direction, the third drive portion 153 is a side surface of the second protrusion 156 facing the third protrusion 157, the fourth drive portion 154 is a side surface of the third protrusion 157 facing the second protrusion 156, and the two side surfaces face each other and are spaced apart in the left and right direction. Under the drive of the first drive mechanism and the second drive mechanism, the delivery device 112 may drive the goods bucket 115 to move such that the first protrusion 155 extends between the second protrusion 156 and the third protrusion 157. After the first protrusion 155 is located between the second protrusion 156 and the third protrusion 157, the delivery device 112 is driven by the first drive mechanism and the second drive mechanism to drive the goods bucket 115 to move horizontally rightward (that is, the preset direction) so that the third drive portion 153 can abut against the first drive portion 149. As the goods bucket 115 continues to move horizontally rightward, the gate 129 moves rightward to open the pickup port 109, and the delivery door 132 moves leftward to open the delivery opening 135. When the goods bucket 115 moves horizontally leftward, the fourth drive portion 154 can abut against the second drive portion 151. As the goods bucket 115 continues to move horizontally leftward, the gate 129 moves leftward to close the pickup port 109, and the delivery door 132 moves rightward to close the delivery opening 135.

With such setting, since the delivery device 112 can drive, under the drive of the first drive mechanism and the second drive mechanism, the goods bucket 115 to move along the up and down direction and the left and right direction, the goods bucket 115 can be driven by the second drive mechanism to move above the first transmission piece 138 and then move downward so that the first protrusion 155 extends between the second protrusion 156 and the third protrusion 157. After the first protrusion 155 is located between the second protrusion 156 and the third protrusion 157, the first drive mechanism drives the delivery device 112 to drive the goods bucket 115 to move rightward so that the third drive portion 153 on the second protrusion 156 abuts against the first drive portion 149 on the first protrusion 155. When the first drive mechanism drives the delivery device 112 to drive the goods bucket 115 to continue to move rightward, the gate 129 opens the pickup port 109, and the delivery door 132 opens the pickup port 109. After the lottery tickets in the goods bucket 115 are taken out, the first drive mechanism drives the delivery device 112 to drive the goods bucket 115 to move leftward so that the third drive portion 153 is disengaged from the first drive portion 149 and the fourth drive portion 154 abuts against the second drive portion 151. When the first drive mechanism drives the delivery device 112 to drive the goods bucket 115 to continue to move leftward, the gate 129 closes the pickup port 109, and the delivery door 132 closes the delivery opening 135.

With such setting, when the pickup port 109 and the delivery opening 135 are required to be opened for delivery, the second drive mechanism drives the delivery device 112 to drive the goods bucket 115 to move along the up and down direction so that the first protrusion 155 extends between the second protrusion 156 and the third protrusion 157, and then the first drive mechanism drives the delivery device 112 to drive the goods bucket 115 to move rightward. Meanwhile, when the pickup port 109 and the delivery opening 135 are required to be closed after pickup, the first protrusion 155 is not required to withdraw from between the second protrusion 156 and the third protrusion 157, and the first drive mechanism directly drives the delivery device 112 in the opposite direction to drive the goods bucket 115 to move leftward so that the pickup port 109 and the delivery opening 135 can be closed. Thus, the gate 129 and the delivery door 132 are linked to open and close with relatively high efficiency.

For example, still referring to FIG. 8, in this embodiment, the first protrusion 155, the second protrusion 156, and the third protrusion 157 are all block-shaped so that when the goods bucket 115 drives the second transmission piece 139 to mate with the first transmission piece 138, the third drive portion 153 can abut against the first drive portion 149 in surface contact, and the fourth drive portion 154 can abut against the second drive portion 151 in surface contact, so as to fully ensure the smoothness and reliability of the process of the delivery door 132 and the gate 129 being linked to open or close. Of course, in other embodiments, a reverse setting may be used, where the first transmission piece 138 includes the first protrusion 155 and the second protrusion 156 which are both block-shaped, and the second transmission piece 139 includes the third protrusion 157 which is block-shaped. During the motion of the goods bucket 115, the third protrusion 157 can extend between the first protrusion 155 and the second protrusion 156 so that the delivery door 132 and the gate 129 can be linked to open and close.

Additionally, in other embodiments, one of the first transmission piece 138 and the second transmission piece 139 may be an engaging groove, and the other of the first transmission piece 138 and the second transmission piece 139 may be an engaging portion. When the engaging portion is snap-fitted with the engaging groove and the goods bucket 115 moves rightward to the delivery position, the second transmission piece 139 drives the first transmission piece 138 to drive the gate 129 to open the pickup port 109, and the first transmission piece 138 drives the second transmission piece 139 to drive the delivery door 132 to open the delivery opening 135. Meanwhile, when the engaging portion is snap-fitted with the engaging groove and the goods bucket 115 leaves the delivery position leftward, the second transmission piece 139 drives the first transmission piece 138 to drive the gate 129 to close the pickup port 109, and the first transmission piece 138 drives the second transmission piece 139 to drive the delivery door 132 to close the delivery opening 135.

In an embodiment, the first transmission piece 138 is fixedly connected to the gate 129, or the first transmission piece 138 is drivingly connected to the gate 129 via a first transition assembly 158; and/or the second transmission piece 139 is fixedly connected to the delivery door 132, or the second transmission piece 139 is drivingly connected to the delivery door 132 via a second transition assembly.

Still referring to FIGS. 3 and 7 to 9, in this embodiment, the first transmission piece 138 is drivingly connected to the gate 129 via the first transition assembly 158, and the second transmission piece 139 is fixedly connected to the delivery door 132 directly. For example, the second transmission piece 139 is welded to, threadedly connected to, or integrally formed with the delivery door 132.

To make the first transmission piece 138 drivingly connected to the gate 129, in this embodiment, the first transition assembly 158 may be disposed at the bottom of the gate 129, and the first transition assembly 158 includes a first rack 159, a second rack 161, and a transmission gear 163. The first rack 159 is fixedly connected to the gate 129, the second rack 161 is slidably connected to the cabinet 101 (the cabinet body 102 or the cabinet door 103), and the first rack 159 and the second rack 161 both extend along the left and right direction (that is, the preset direction). A toothed portion of the first rack 159 and a toothed portion of the second rack 161 face each other and are spaced apart from each other. The transmission gear 163 is disposed on the cabinet 101 and meshes with both the toothed portion of the first rack 159 and the toothed portion of the second rack 161, and the first transmission piece 138 is fixedly connected to the second rack 161 and protrudes relative to the second rack 161.

With such setting, when the delivery device 112 is driven to drive the goods bucket 115 to move so that the first protrusion 155 extends between the second protrusion 156 and the third protrusion 157, the goods bucket 115 moves rightward (that is, the goods bucket 115 moves along the preset direction), and the third drive portion 153 abuts against the first drive portion 149 and can drive the second rack 161 to move rightward so that the second rack 161 can drive the transmission gear 163 to rotate, and the transmission gear 163 can drive the first rack 159 and the gate 129 to move leftward to open the pickup port 109. Conversely, the goods bucket 115 moves leftward (that is, the goods bucket 115 moves along the direction opposite to the preset direction) and can drive the second rack 161 to move leftward synchronously so that the second rack 161 can drive the transmission gear 163 to rotate, and the transmission gear 163 can drive the first rack 159 and the gate 129 to move rightward to close the pickup port 109. That is, the first transition assembly 158 is disposed so that a direction in which the gate 129 opens the pickup port 109 can be consistent with a direction in which the delivery door 132 opens the delivery opening 135. Thus, when the gate 129 opens the pickup port 109 and the delivery door 132 opens the delivery opening 135, the gate 129 and the delivery door 132 can be opposite to each other in the front and rear direction, thereby reducing a space occupied by the gate 129 and the delivery door 132 in the left and right direction and facilitating the improvement of the structural compactness of the vending machine 100.

As an optional solution, in this embodiment, the first protrusion 155 is fixedly disposed at an end of the second rack 161 near the pivotal position between the cabinet door 103 and the cabinet body 102. Along the motion direction of the delivery door 132, the second protrusion 156 and the third protrusion 157 are fixedly disposed on the side of the delivery door 132 away from the pivotal position between the cabinet door 103 and the cabinet body 102. With such setting, when the gate 129 closes the pickup port 109, the delivery door 132 closes the delivery opening 135, and the first protrusion 155 is located between the second protrusion 156 and the third protrusion 157, along the motion direction of the gate 129, the delivery door 132 is spaced apart from the gate 129, the first transmission piece 138 is located on a side of the gate 129 near the delivery door 132, and the second transmission piece 139 is located at an end of the delivery door 132 near the gate 129. After such setting, during the motion of the goods bucket 115, the second protrusion 156 and the third protrusion 157 on the delivery door 132 can promptly abut against the first protrusion 155 on the second rack 161 so that when the goods bucket 115 moves to the delivery position, both the gate 129 and the delivery door 132 can completely open, thereby improving the efficiency with which the goods bucket 115 drives the linkage between the delivery door 132 and the gate 129.

Optionally, still referring to FIG. 9, in this embodiment, the transmission gear 163 includes a first gear 165 and a second gear 167 that are coaxially and fixedly connected to each other. The tip diameter of the first gear 165 is larger than the tip diameter of the second gear 167, the first gear 165 meshes with the first rack 159, and the second gear 167 meshes with the second rack 161. With such setting, when moving a relatively small stroke, the second rack 161 can drive the first rack 159 to drive the gate 129 to move a relatively large stroke so that the gate 129 can quickly open or close the pickup port 109.

It is to be noted that in this embodiment, the first transmission piece 138 is integrally formed with the second rack 161, and the second transmission piece 139 is integrally formed with the delivery door 132 so that connection strength can be ensured to fully improve the motion smoothness and reliability of the gate 129 and the delivery door 132. Of course, in other embodiments, a detachable connection (for example, by use of a screw) may be adopted as long as the motion smoothness and reliability of the gate 129 and the delivery door 132 can be ensured.

In other embodiments, the first transmission piece 138 may be fixedly connected to the gate 129 directly, and the second transmission piece 139 may be drivingly connected to the delivery door 132 via the second transition assembly. The second transition assembly may adopt a structure similar to that of the first transition assembly 158. For example, the second transition assembly includes a third rack, a fourth rack, and a transition gear, where the third rack is fixedly connected to the delivery door 132, the fourth rack is slidably connected to the housing 131, and the third rack and the fourth rack both extend along the left and right direction (that is, the preset direction). A toothed portion of the third rack and a toothed portion of the fourth rack face each other and are spaced apart. The transition gear is disposed on the housing 131 and meshes with both the toothed portion of the third rack and the toothed portion of the fourth rack, the second transmission piece 139 is fixedly connected to the fourth rack, and the second protrusion 156 and the third protrusion 157 of the second transmission piece 139 both protrude relative to the fourth rack. With such setting, when the delivery device 112 is driven to drive the goods bucket 115 to move so that the first protrusion 155 extends between the second protrusion 156 and the third protrusion 157, the goods bucket 115 moves rightward (that is, the goods bucket 115 moves along the preset direction), the third drive portion 153 abuts against the first drive portion 149 and can drive the fourth rack to move leftward so that the fourth rack can drive the transition gear to rotate, and the transition gear can drive the third rack and the delivery door 132 to move rightward to open the delivery opening 135, and the gate 129 can be driven to move rightward to open the pickup port 109. Conversely, the goods bucket 115 moves leftward (that is, the goods bucket 115 moves along the direction opposite to the preset direction) and can drive the fourth rack to move rightward so that the transition gear can drive the third rack and the delivery door 132 to move leftward to close the delivery opening 135, and the gate 129 can be driven to move leftward to close the pickup port 109.

Still referring to FIGS. 3 and 8, in this embodiment, the linkage mechanism 137 may be further provided with a guide assembly as required. The guide assembly includes a guide groove 168 and a guide portion 169 extending along the motion direction of the gate 129 (the left and right direction in this embodiment). The guide groove 168 is disposed on one of the second rack 161 and the cabinet 101, and the guide portion 169 is disposed on the other of the second rack 161 and the cabinet 101. The guide portion 169 mates with the guide groove 168 in an inserted manner. When the gate 129 opens or closes the pickup port 109, the guide groove 168 and the guide portion 169 slide relative to each other. The guide groove 168 and the guide portion 169 are disposed to ensure the motion smoothness of the second rack 161, thereby improving the reliability with which the gate 129 and the delivery door 132 are opened and closed.

For example, in this embodiment, the guide assembly includes two guide grooves 168 and two guide portions 169 in one-to-one correspondence with the two guide grooves 168. The two guide grooves 168 are located on the front and rear sides of the second rack 161, respectively. The two guide portions 169 are both disposed on the cabinet door 103 of the cabinet 101. The two guide portions 169 are inserted into the two guide grooves 168 in one-to-one correspondence. With such setting, the second rack 161 is prevented from shaking along the front and rear direction, and the motion smoothness of the second rack 161 can be improved, thereby improving the smoothness and reliability with which the gate 129 and the delivery door 132 are opened and closed.

Still referring to FIGS. 1 and 2, to ensure efficient ticket sales, in this embodiment, the vending machine 100 further includes at least one of a banknote receiving device 107, a barcode scanning device 106, a printing device 105, and a card identification device 108. For example, the vending machine 100 further includes the banknote receiving device 107, the banknote receiving device 107 is disposed on the cabinet door 103 and exposed from an opening of the cabinet door 103, and the banknote receiving device 107 is electrically or communicatively connected to the controller and configured to receive a banknote inserted by the user when the user purchases the lottery tickets. For example, the vending machine 100 further includes the barcode scanning device 106, and the barcode scanning device 106 is also disposed on the cabinet door 103 and is configured for the user to scan barcode information to complete payment or acquire the information about the lottery ticket. For example, the vending machine 100 further includes the printing device 105, the printing device 105 is disposed in the cabinet body 102, an outlet of the printing device 105 is exposed from the cabinet door 103, and the printing device 105 is electrically or communicatively connected to the controller and configured to print a credential for the user to store after the output of the lottery tickets. For example, the vending machine 100 further includes the card identification device 108, the card identification device 108 is disposed in the cabinet body 102 and exposed from an opening of the cabinet door 103, and the card identification device 108 can identify an identity card or a bank card to assist in the ticket sales.

Of course, in other embodiments, the vending machine 100 may further include a keyboard for the user to input a password; the vending machine 100 may further include a fingerprint recognition device for fingerprint recognition of a staff during equipment maintenance and may even be provided with a display screen or a touch screen as required, where the display screen or the touch screen is for use by the user or the staff.

The working process and beneficial effects of the vending machine 100 according to the embodiment of the present application are described below.

When the user purchases the lottery tickets, the user inserts a banknote of an amount corresponding to the purchased lottery tickets into the banknote receiving device 107, or the user performs payment by scanning a barcode through the barcode scanning device 106. After receiving the payment information of the user, the controller may control the delivery device 112 through the first drive mechanism and the second drive mechanism to drive the goods bucket 115 to move to the receiving position so that an inlet of the ticket dispensing device 113 is docked with an outlet of the target ticket output device 111. The controller controls the ticket output device 111 to output the lottery tickets to the ticket dispensing channel of the ticket dispensing device 113. The controller controls the identification assembly in the ticket dispensing device 113 to collect information about the lottery tickets, activates the lottery tickets, controls the cutting assembly to cut the lottery tickets into single lottery tickets, and controls the conveying rollers to send the single lottery tickets out, where the single lottery tickets enter the receiving cavity 180 of the goods bucket 115 through the goods entry opening 133. Next, the controller controls the first drive mechanism and the second drive mechanism to drive the delivery device 112 to drive the goods bucket 115 to move toward the pickup port 109 to make the first protrusion 155 extend between the second protrusion 156 and the third protrusion 157 and then controls the first drive mechanism to drive the delivery device 112 to drive the goods bucket 115 to move rightward to the delivery position so that the third drive portion 153 abuts against the first drive portion 149, the third drive portion 153 drives the first drive portion 149 to drive the second rack 161 to move rightward so as to drive the first rack 159 and the gate 129 to move leftward to open the pickup port 109, and the first drive portion 149 drives the third drive portion 153 to drive the delivery door 132 to move leftward to open the delivery opening 135. Thus, when the goods bucket 115 moves to the delivery position, the delivery opening 135 is opposite to and in communication with the pickup port 109 so that the user can directly take out the lottery tickets in the receiving cavity 180 through the pickup port 109 and the delivery opening 135.

After the user takes away the lottery tickets, the controller continues to control the first drive mechanism to drive the delivery device 112 to drive the goods bucket 115 to move leftward, the fourth drive portion 154 abuts against the second drive portion 151, the fourth drive portion 154 drives the second drive portion 151 to drive the second rack 161 to move leftward so as to drive the first rack 159 and the gate 129 to move rightward to close the pickup port 109, and the second drive portion 151 drives the fourth drive portion 154 to drive the delivery door 132 to move rightward to close the delivery opening 135. Finally, the controller controls the locking motor 143 to drive the locking piece 142 to pass through the notch 175 and extend into the locking hole 176 on the gate 129 to lock the position of the gate 129.

In the preceding process, in one aspect, the vending machine 100 is provided with the linkage mechanism 137 so that the motion of the goods bucket 115 to the delivery position can drive the gate 129 and the delivery door 132 to be linked to open. Thus, drive structures for the gate 129 and the delivery door 132 are omitted, and separate drive structures are no longer required to be disposed for the gate 129 and the delivery door 132, thereby simplifying the structure and saving the cost. In the other aspect, the motion of the goods bucket 115 to the delivery position occurs simultaneously with at least one of the following two actions: the delivery door 132 opens the delivery opening 135 or the gate 129 opens the pickup port 109, thereby improving the delivery efficiency, reducing the waiting time of the user, and improving the user experience.

To conclude, the embodiment of the present application provides the vending machine 100 where the gate 129 and the delivery door 132 can be linked to open or close under the drive of the goods bucket 115 and which is simple in structure and can effectively reduce the cost.

1. A vending machine, comprising:
a cabinet, wherein a storage region for storing goods is provided in the cabinet, and a pickup port is defined on a surface of the cabinet;
a gate mechanism comprising a gate slidably mating with the cabinet and configured to open or close the pickup port;
a goods bucket comprising a housing and a delivery door, wherein the housing has a delivery opening, the delivery door slidably mates with the housing to open or close the delivery opening, and when the delivery door closes the delivery opening, the delivery door and the housing form a receiving cavity for receiving goods; the goods bucket is movably disposed in the cabinet and has a receiving position and a delivery position; the goods bucket is configured to receive goods from the storage region when the goods bucket is at the receiving position; and when the goods bucket is at the delivery position, the gate opens the pickup port, and the delivery door opens the delivery opening, the delivery opening is opposite to and in communication with the pickup port; and
a linkage mechanism capable of linking the delivery door to the gate when the goods bucket moves toward the delivery position along a preset direction, such that the delivery door opens the delivery opening and the gate opens the pickup port.

2. The vending machine according to claim 1, wherein the linkage mechanism comprises a first transmission piece and a second transmission piece capable of mating with each other, the first transmission piece is connected to the gate, and the second transmission piece is connected to the delivery door; and
when the first transmission piece and the second transmission piece mate with each other and the goods bucket moves toward the delivery position along the preset direction, the second transmission piece drives the first transmission piece to drive the gate to open the pickup port, and the first transmission piece drives the second transmission piece to drive the delivery door to open the delivery opening, so that the delivery opening is opposite to and in communication with the pickup port.

3. The vending machine according to claim 2, wherein the first transmission piece comprises a first drive portion and a second drive portion; and the second transmission piece comprises a third drive portion and a fourth drive portion;
when the third drive portion abuts against the first drive portion and the goods bucket moves toward the delivery position along the preset direction, the third drive portion drives the first drive portion to drive the gate to open the pickup port, and the first drive portion drives the third drive portion to drive the delivery door to open the delivery opening; and
when the fourth drive portion abuts against the second drive portion and the goods bucket leaves the delivery position along a direction opposite to the preset direction, the fourth drive portion drives the second drive portion to drive the gate to close the pickup port, and the second drive portion drives the fourth drive portion to drive the delivery door to close the delivery opening.

4. The vending machine according to claim 3, wherein the preset direction is either horizontally leftward or horizontally rightward; or the preset direction is either vertically upward or vertically downward.

5. The vending machine according to claim 3, wherein the first transmission piece comprises a first protrusion, the first drive portion and the second drive portion are disposed on the first protrusion, and the first drive portion and the second drive portion face away from each other;
the second transmission piece comprises a second protrusion and a third protrusion spaced apart from each other, the third drive portion is disposed on the second protrusion, the fourth drive portion is disposed on the third protrusion, and the fourth drive portion and the third drive portion face each other; and
the first protrusion is capable of entering between the second protrusion and the third protrusion, so that when the goods bucket moves along the preset direction, the third drive portion is capable of abutting against the first drive portion, and when the goods bucket moves along the direction opposite to the preset direction, the fourth drive portion is capable of abutting against the second drive portion.

6. The vending machine according to claim 2, wherein the first transmission piece is fixedly connected to the gate, or the first transmission piece is drivingly connected to the gate via a first transition assembly.

7. The vending machine according to claim 2, wherein the second transmission piece is fixedly connected to the delivery door, or the second transmission piece is drivingly connected to the delivery door via a second transition assembly.

8. The vending machine according to claim 6, wherein the first transmission piece is drivingly connected to the gate via the first transition assembly; and
the first transition assembly comprises a first rack, a second rack, and a transmission gear; the first rack is fixedly connected to the gate, and the second rack is slidably connected to the cabinet; the first rack and the second rack extend along the preset direction, and the toothed portion of the first rack and the toothed portion of the second rack face each other and are spaced apart from each other; the transmission gear is disposed on the cabinet and meshes with both the toothed portion of the first rack and the toothed portion of the second rack, and the first transmission piece is fixedly connected to the second rack.

9. The vending machine according to claim 2, wherein one of the first transmission piece and the second transmission piece is an engaging groove, and another of the first transmission piece and the second transmission piece is an engaging portion;
when the engaging portion is snap-fitted with the engaging groove and the goods bucket moves toward the delivery position along the preset direction, the second transmission piece drives the first transmission piece to drive the gate to open the pickup port, and the first transmission piece drives the second transmission piece to drive the delivery door to open the delivery opening; and
when the engaging portion is snap-fitted with the engaging groove and the goods bucket leaves the delivery position along a direction opposite to the preset direction, the second transmission piece drives the first transmission piece to drive the gate to close the pickup port, and the first transmission piece drives the second transmission piece to drive the delivery door to close the delivery opening.

10. The vending machine according to claim 1, wherein the goods bucket further comprises a first elastic element, the first elastic element is connected between the housing and the delivery door, the first elastic element is configured to make the delivery door always have a motion tendency to close the delivery opening, and the delivery door is capable of closing the delivery opening under an action of the first elastic element and/or a gravity of the delivery door; and
the gate mechanism further comprises a second elastic element, the second elastic element is connected between the gate and the cabinet, the second elastic element is configured to make the gate always have a motion tendency to close the pickup port, and the gate is capable of closing the pickup port under an action of the second elastic element and/or a gravity of the gate.

11. The vending machine according to claim 1, wherein a ticket output device is provided in the storage region and configured to store and output lottery tickets; the vending machine further comprises a ticket dispensing device disposed in the cabinet and fixedly connected to the goods bucket; and when the goods bucket is at the receiving position, the ticket dispensing device is opposite to the ticket output device, and the ticket dispensing device is configured to receive the lottery tickets output from the ticket output device and output the lottery tickets to the goods bucket.

12. The vending machine according to claim 3, wherein one of the first transmission piece and the second transmission piece is an engaging groove, and another of the first transmission piece and the second transmission piece is an engaging portion;
when the engaging portion is snap-fitted with the engaging groove and the goods bucket moves toward the delivery position along the preset direction, the second transmission piece drives the first transmission piece to drive the gate to open the pickup port, and the first transmission piece drives the second transmission piece to drive the delivery door to open the delivery opening; and
when the engaging portion is snap-fitted with the engaging groove and the goods bucket leaves the delivery position along a direction opposite to the preset direction, the second transmission piece drives the first transmission piece to drive the gate to close the pickup port, and the first transmission piece drives the second transmission piece to drive the delivery door to close the delivery opening.

13. The vending machine according to claim 2, wherein the goods bucket further comprises a first elastic element, the first elastic element is connected between the housing and the delivery door, the first elastic element is configured to make the delivery door always have a motion tendency to close the delivery opening, and the delivery door is capable of closing the delivery opening under an action of the first elastic element and/or a gravity of the delivery door; and
the gate mechanism further comprises a second elastic element, the second elastic element is connected between the gate and the cabinet, the second elastic element is configured to make the gate always have a motion tendency to close the pickup port, and the gate is capable of closing the pickup port under an action of the second elastic element and/or a gravity of the gate.

14. The vending machine according to claim 3, wherein the goods bucket further comprises a first elastic element, the first elastic element is connected between the housing and the delivery door, the first elastic element is configured to make the delivery door always have a motion tendency to close the delivery opening, and the delivery door is capable of closing the delivery opening under an action of the first elastic element and/or a gravity of the delivery door; and
the gate mechanism further comprises a second elastic element, the second elastic element is connected between the gate and the cabinet, the second elastic element is configured to make the gate always have a motion tendency to close the pickup port, and the gate is capable of closing the pickup port under an action of the second elastic element and/or a gravity of the gate.

15. The vending machine according to claim 4, wherein the goods bucket further comprises a first elastic element, the first elastic element is connected between the housing and the delivery door, the first elastic element is configured to make the delivery door always have a motion tendency to close the delivery opening, and the delivery door is capable of closing the delivery opening under an action of the first elastic element and/or a gravity of the delivery door; and
the gate mechanism further comprises a second elastic element, the second elastic element is connected between the gate and the cabinet, the second elastic element is configured to make the gate always have a motion tendency to close the pickup port, and the gate is capable of closing the pickup port under an action of the second elastic element and/or a gravity of the gate.

16. The vending machine according to claim 5, wherein the goods bucket further comprises a first elastic element, the first elastic element is connected between the housing and the delivery door, the first elastic element is configured to make the delivery door always have a motion tendency to close the delivery opening, and the delivery door is capable of closing the delivery opening under an action of the first elastic element and/or a gravity of the delivery door; and
the gate mechanism further comprises a second elastic element, the second elastic element is connected between the gate and the cabinet, the second elastic element is configured to make the gate always have a motion tendency to close the pickup port, and the gate is capable of closing the pickup port under an action of the second elastic element and/or a gravity of the gate.

17. The vending machine according to claim 2, wherein a ticket output device is provided in the storage region and configured to store and output lottery tickets; the vending machine further comprises a ticket dispensing device disposed in the cabinet and fixedly connected to the goods bucket; and when the goods bucket is at the receiving position, the ticket dispensing device is opposite to the ticket output device, and the ticket dispensing device is configured to receive the lottery tickets output from the ticket output device and output the lottery tickets to the goods bucket.

18. The vending machine according to claim 3, wherein a ticket output device is provided in the storage region and configured to store and output lottery tickets; the vending machine further comprises a ticket dispensing device disposed in the cabinet and fixedly connected to the goods bucket; and when the goods bucket is at the receiving position, the ticket dispensing device is opposite to the ticket output device, and the ticket dispensing device is configured to receive the lottery tickets output from the ticket output device and output the lottery tickets to the goods bucket.

19. The vending machine according to claim 4, wherein a ticket output device is provided in the storage region and configured to store and output lottery tickets; the vending machine further comprises a ticket dispensing device disposed in the cabinet and fixedly connected to the goods bucket; and when the goods bucket is at the receiving position, the ticket dispensing device is opposite to the ticket output device, and the ticket dispensing device is configured to receive the lottery tickets output from the ticket output device and output the lottery tickets to the goods bucket.

20. The vending machine according to claim 5, wherein a ticket output device is provided in the storage region and configured to store and output lottery tickets; the vending machine further comprises a ticket dispensing device disposed in the cabinet and fixedly connected to the goods bucket; and when the goods bucket is at the receiving position, the ticket dispensing device is opposite to the ticket output device, and the ticket dispensing device is configured to receive the lottery tickets output from the ticket output device and output the lottery tickets to the goods bucket.
